(19) United States
(12) Patent Application Publication
(10) Pub. No.: US 2003/0198530 A1
(43) Pub. Date: Oct. 23, 2003

(54) Device for fastening tubular objects

(76) Inventors: Armin Hoffmann, Landsberg (DE); Armin Herb, Apfeldorf (DE); Stefan Unverzagt, Penzing (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/411,166

(22) Filed: Apr. 10, 2003

(30) Foreign Application Priority Data
Apr. 19, 2002 (DE) 102 17 554.3

(51) Int. Cl. F16B 27/00

(52) U.S. Cl. 411/84

(57) ABSTRACT

A device for fastening tubular objects includes a C-shaped mounting rail (3) and retaining plate (2) having a threaded through-bore (8), with the width (b1) measured in a direction parallel to the retaining plate plane and corresponding at most to a width (b2) of the elongate opening (2) of the mounting rail (3), a length (c) measured transverse to the width direction and which is greater than the width (b2) of the elongate opening (2) of the mounting rail (3), and at least one web (14a, 14b; 22) provided on its side adjacent to the elongate opening formed in the mounting rail.

### BACKGROUND OF THE INVENTION

1. Field of the Invention

The present invention relates to a device for fastening tubes and tubular objects and includes a C-shaped mounting rail having an elongate opening, and a retaining plate having a through-bore extending transverse to a plane of the retaining plate and provided with an inner thread, a width measured in a direction parallel to the retaining plate plane and corresponding at most to a width of the elongate opening of the mounting rail, and a length measured transverse to the width direction and which is greater than the width of the elongate opening.

2. Description of the Prior Art

Fastening devices of the type described above find particular application for suspending and bracing of objects such as, e.g., tubes and the like. To this end, a mounting rail having an elongate opening is secured to a constructional component or part, e.g., with several segment anchors. For fastening a fastening element, a retaining plate is inserted into the interior of the mounting rail through the rail elongate opening and is pivoted by an angle, e.g., 90° and engages, from behind the free ends, so-called retaining projections. For securing a fastening element, e.g., a threaded rod, the retaining plate has a through-bore provided with an inner thread that form-lockingly engages a complementary outer profile provided at least on a portion of the fastening element. In order to insure the insertion of the retaining plate through the elongate opening, the width of the retaining plate corresponds at most to the width of the elongate opening provided in the mounting rail. The engagement of the retaining projection of the mounting rail by the retaining plate is insured by having the length of the retaining plate, which is measured transverse to the width direction of the retaining plate, greater than the width of the elongate opening.

German Patent DE 38 11 794 C2 discloses a fastening device including a C-shaped mounting rail and non-circular retaining part which is formed, e.g., as a cast part.

The drawback of the known device consists in that for producing the retaining part, a lot of material is spent in order to obtained the desired dimensions, which adversely affects the economy of the production.

A further drawback consists in that the excessive weight of the retaining part increases the overall weight of the fastening device, in particular, when several retaining plates are required.

Accordingly, an object of the invention is a fastening device including a retaining plate that can be economically produced and has a reduced weight.

Another object of the invention is a fastening device including a retaining plate that would insure a high stability and would exhibit a good performance under tension loads.

### SUMMARY OF THE INVENTION

These and other objects of the present invention, which will become apparent hereinafter, are achieved by providing, in the device of the type described above, a retaining plate having at least one web on a side of retaining plate adjacent to the elongate opening of the mounting rail. The web provides for stiffening the retaining plate and for its positioning with respect to the mounting rail.

Providing a stiffening and positioning web permits to form a plate with less consumption of the material and that would weigh less than a conventional retaining plate. At least one web further insures a reliable positioning of the used fastening element. The at least one web defines an additional space for receiving the fastening element and which extends coaxially with the inner bore of the retaining plate. This permits to use fastening elements which do not have a precise length.

At the same time, the retaining plate according to the present invention occupies less space in the mounting rail than a cast plate or a plate formed of a sheet metal and provide with a reinforcement on its top for increasing its stability.

Advantageously, there are provided two, arranged parallel to each other, stiffening and reinforcing webs. The webs dependent on the requirements, can have different cross-sections such as, e.g., round, rectangular or the like cross-sections. The dimensions of the webs depend on the space available for the fastening device.

Advantageously, the two webs are provided on opposite sides of the inner thread which insures an optimal stability in the region of the inner thread as the thread causes weakness of the plate in this area.

Advantageously, the retaining plate has a U-shaped profile, with the free ends of the profile forming the webs. This shape proved to be optimal for reducing the material consumption and the production costs.

The webs are advantageously provided, on sides of the inner thread, with beads, which reduces overload in the region of the inner thread. In fastening devices which are subjected to a load in their foreground, the webs are wave-shaped over their entire length, which increases their stability. In addition, the beads function as predetermined bending points, protecting the mounting rail and, thus, the fastening device from an overload.

To provide for its economical manufacturing, the retaining plate has a uniform wall thickness.

Advantageously, a side of the retaining plate remote from the elongate opening projects, at least in a region of the inner thread, beyond a remaining region of the remote from the elongate opening, side of the retaining plate. This insures an adequate axial extent of the inner thread, on one hand, and, on the other hand, minimizes the height of the webs in the axial direction of the inner thread.

An axial extent of the inner thread advantageously corresponds to about 1.5-4.5 times, preferably, to 2.25 times of the wall thickness of the retaining plate.

Advantageously, the retaining plate is formed as a stamped bent part, which insures its economical manufacturing.

Advantageously, the mounting rail is provided, at its free edges, with recesses a width of which at least corresponds to a wall thickness of the retaining plate, and wherein the stiffening and positioning webs of the retaining plate engage in the recesses. At least one of the retaining plate webs engages in a corresponding recess. This reduces displacement of the retaining plate in the longitudinal direction of the mounting plate under forces acting in the longitudinal direction of the mounting rail. The distance between separate recesses, which are provided at the free edge, advantageously corresponds to the dimensions of the retaining plate. The recesses preferably have a rectangular cross-section in the longitudinal direction.

The novel features of the present invention, which are considered as characteristic for the invention, are set forth in the appended claims. The invention itself, however both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional view of a fastening device according to the present invention with a longitudinal extending, fastening element;

FIG. 2 a plan view of a retaining element shown in FIG. 1;

FIG. 3 a cross-sectional view of the retaining element taken along line III-III in FIG. 1;

FIG. 4 a cross-sectional view of the retaining element taken along line IV-IV in FIG. 2;

FIG. 5 a plan view of a retaining element with beads;

FIG. 6 a plan view of a another embodiment of a retaining element for a fastening device shown in FIG. 1; and

FIG. 7 a cross-sectional view of the retaining element along line VII-VII in FIG. 6.

### DETAILED DESCRIPTION OF THE PREFERRED EMBODIMENTS

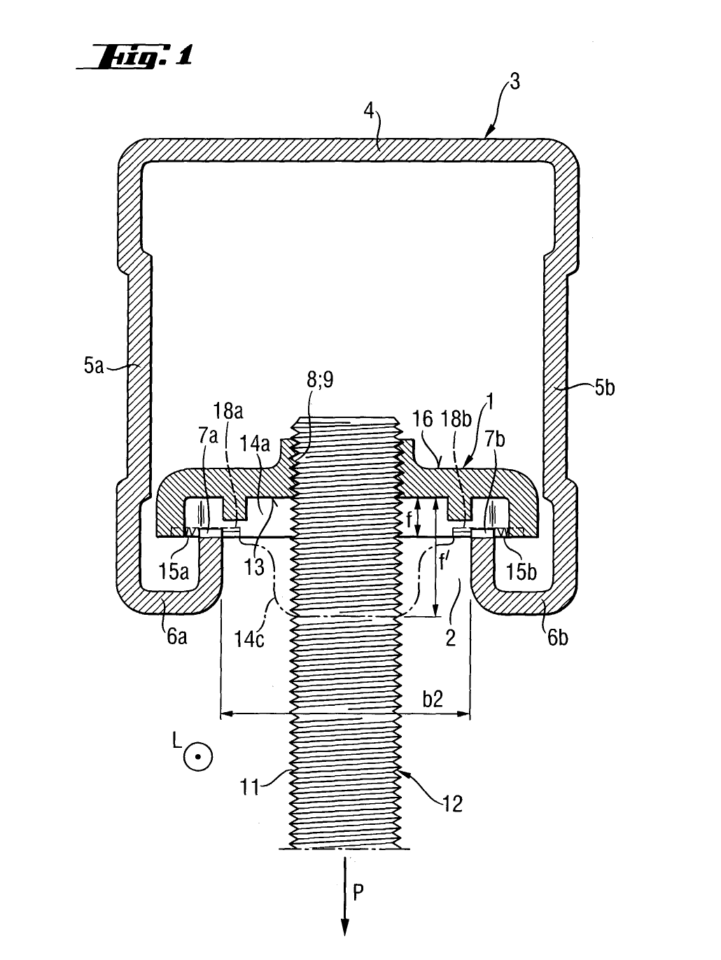

A fastening device according to the present invention, which is shown in FIG. 1, has a C-shaped cross-section and includes a mounting rail 3 provided with an elongate opening 2, and a retaining element or plate 1.

The elongate mounting rail 3, which is shown in FIG. 1, has a substantially C-shaped cross-section and is formed, preferably, of a single strip of a galvanized or stainless metal sheet.

The mounting rail 3 has a rear wall 4 and two side walls 5a and 5b provided at opposite longitudinal sides of the rear wall and extending substantially perpendicular to the rear wall 4. At their free front ends, the side walls 5a, 5b are bent inward at a substantially right angle and form two webs 6a and 6b extending parallel to the rear wall 4. The webs 6a, 6b form the elongate opening 2 which extends in the longitudinal direction L of the mounting rail 3. The sides of the webs 6a, 6b adjacent to the rear wall 4 can be provided with the straight knurls 7a, 7b, respectively.

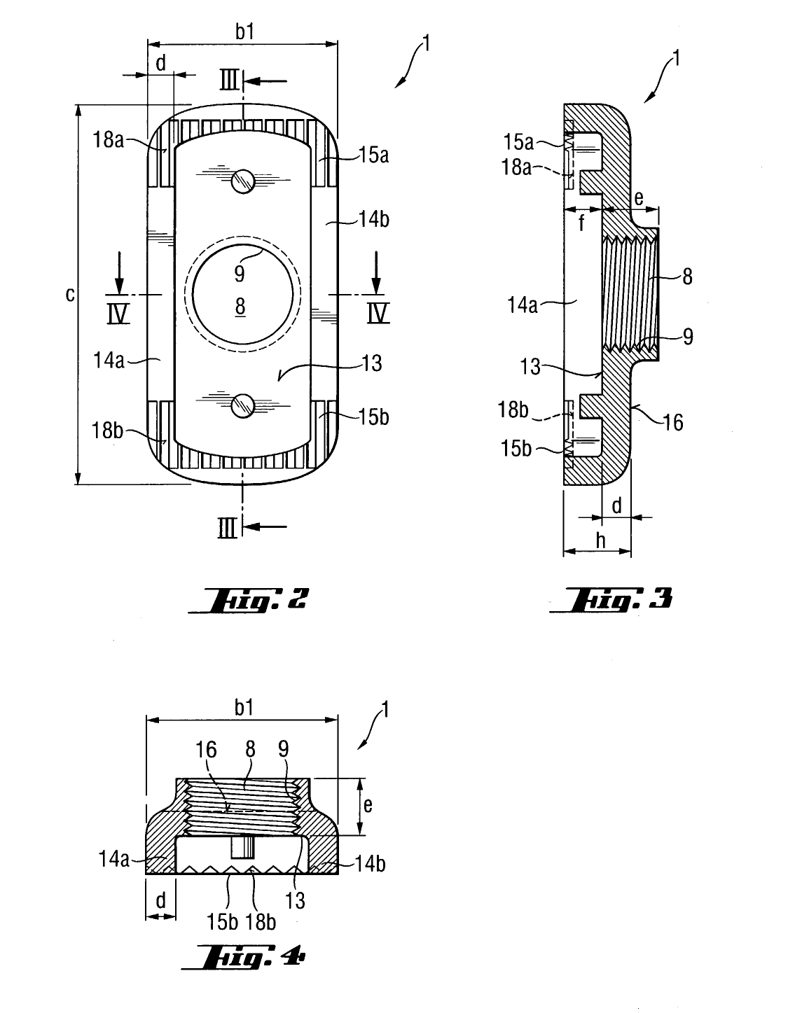

The retaining plate 1 has a through-bore 8 extending transverse to the plate plane and provided with an inner thread 9, as particularly shown in FIGS. 2-4. The through-bore 8 is designed for receiving a fastening element, in particular a bolt 12 provided with an outer thread 11, as shown in FIG. 1 and FIG. 5. The retaining plate 1 has, in a direction parallel to the plate plane, a width b1 that approximately corresponds to the width b2 of the elongate opening 2, and has, transverse to its width dimension, in the direction parallel to the plate plane, a length c that is greater than the width b2 of the elongate opening 2. The retaining plate 1 has a uniform width d.

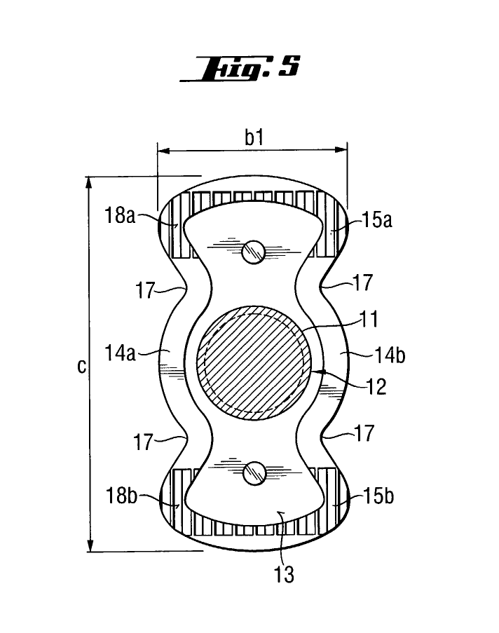

The U-shaped retaining a plate 1 has at its side 13 adjacent to the opening 2, two stiffening and positioning webs 14a, 14b which form free legs, as particularly shown in FIG. 4. The webs 14a, 14b extend in the longitudinal direction of the retaining plate 1 perpendicular to its side 13 adjacent to the elongate opening 2, and have a height f.

Dependent on the dimensions and on the use of the fastening means that cooperates with the retaining plate 1 (e.g., of the bolt 12), the webs 14a, 14b can project, regionwise, beyond bearing areas 15a, 15b. The web elevation 14c, which serves regionwise as stiffening and positioning means, represents a modification of the retaining plate 1 and is shown in FIG. 1 with a dot-dash line. The axial extent f¹ of the web elevation 14c and the wall thickness d of the retaining plate 1 in this case is greater than the height h that corresponds to the distance between the bearing areas 15a, 15b and the outer side 16 of the retaining plate 1. The side 16 of the retaining plate 1 remote from the opening 2, projects, in the region of the inner thread 9, beyond the remaining region of the side 16, as particularly shown in FIGS. 3 and 4. An axial extent e of the inner thread 9 corresponds approximately to 2.25 times of the wall thickness d. The retaining plate 1 can be formed, e.g., as a stamped bent part.

The bearing regions 15a, 15b have, preferably, a straight knurl 18a, 18b, respectively, engageable with a respective straight knurl 7a, 7b provided on the free ends of webs 6a, 6b of the mounting rail 3.

In the embodiment shown in FIG. 5, the webs 14a, 14b have additionally two beads 17 surrounding the inner thread 9. The beads 17 serve, on one hand, for stabilizing the inner thread 9 and, on the other hand, as overload protection means for the fastening device. When a two high load p acts on the fastening element, in particular, on the bolt 12, the retaining plate 1 would bulge in the region of the beads 17. The overload protection prevents failure of the entire fastening device at an unpermissible high load p acting on the device.

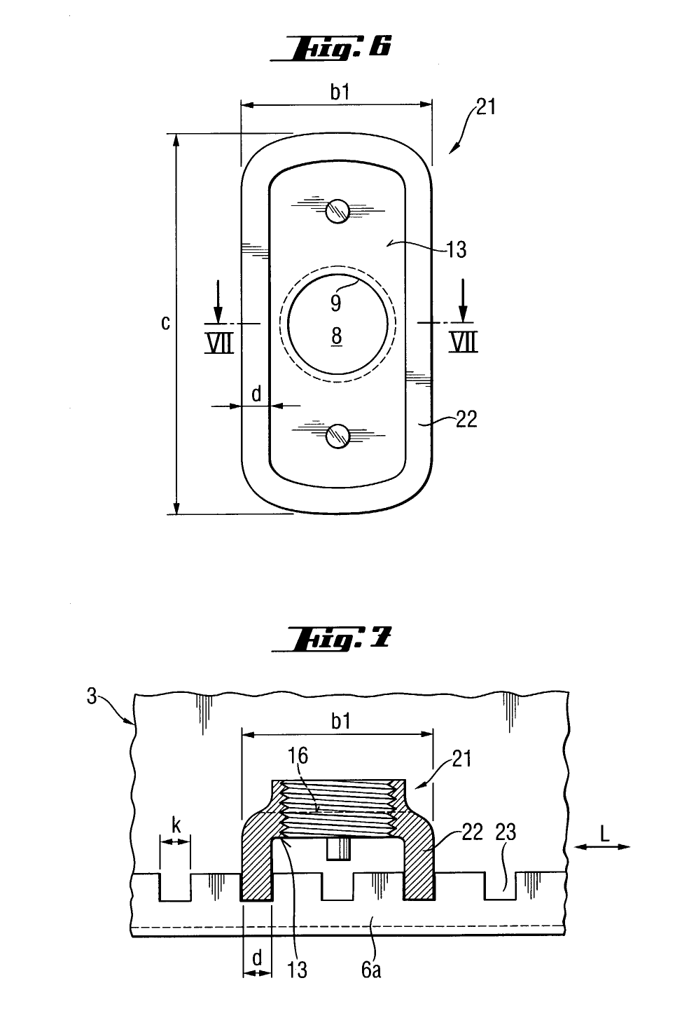

Contrary to the retaining plate 1 shown in FIGS. 2 and 5, the retaining plate 21, which is shown in FIG. 6, has only one circumferential web 22 provided on the side 13 of the retaining plate 21 adjacent to the elongate opening 2. A straight knurl in the bearing areas 15a, 15b of the retaining plate 21 is eliminated in this embodiment of the retaining plate.

FIG. 7 shows a web 6a of the mounting rail 3 a free edge of which, as well as the free edge of the web 6b, have, instead of a knurling surface, a toothing 23. The width k of separate indentations of the toothing 23 only slightly wider than the width d of the retaining plate 21. The spacing between the separate indentations of the toothing 23 corresponds to the dimension b1, so that the web 22 can engage in this indentations to retain the retaining plate 21 against forces which act in the longitudinal direction of the mounting rail 3.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A device for fastening of tubular objects, comprising:
a C-shaped mounting rail (3) having an elongate opening (2); and
a retaining plate (1; 21) having a through-bore (8) extending transverse to a plane of the retaining plate and provided with an inner thread (9), a width (b1) measured in a direction parallel to the retaining plate plane and corresponding at most to a width (b2) of the elongate opening (2) of the mounting rail (3), a length (c) measured transverse to a width direction thereof and which is greater than the width (b2) of the elongate opening (2) of the mounting rail (3), and at least one web (14a, 14b; 22) provided on a side of the retaining plate (1) adjacent to the elongate opening.

2. A fastening device according to claim 1, wherein the retaining plate (1) has two, extending parallel to each other, webs (14a, 14b).

3. A fastening device according to claim 2, wherein the two webs (14a, 14b) are provided on opposite sides of the inner thread (9).

4. A fastening device according to claim 3, wherein the retaining plate (1; 21) has a U-shaped cross-section, and wherein free ends of the U-shaped profile form the two webs (14a, 14b; 22).

5. A fastening device according to claim 3, wherein at least one of the two webs (14a, 14b) has a bead (17) adjacent to the inner thread (9).

6. A fastening device according to claim 1, wherein the retaining plate (1; 21) has a uniform thickness (d).

7. A fastening device according to claim 1, wherein a side (16) of the retaining plate (1) remote from the elongate opening (2) projects, at least in a region of the inner thread (9), beyond a remaining region of the remote from the elongate opening, side (16) of the retaining plate (1).

8. A fastening device according to claim 1, wherein the inner thread (9) has an axial extent (e) corresponding to 1.5-4.5 times of a wall thickness (d) of the retaining plate (1).

9. A fastening device according to claim 1, wherein the retaining plate (1; 21) is formed as a stamped bent part.

10. A fastening device according to claim 4, wherein the mounting rail (3) has, at free edges thereof, recesses (23) a width of which at least corresponds to a wall thickness (d) of the retaining plate (1), and wherein the webs (22) of the retaining plate (1) engage in the recesses (23).
